(19) United States
(12) Patent Application Publication
(10) Pub. No.: US 2011/0064936 A1
(43) Pub. Date: Mar. 17, 2011

(54) Method of Asymmetrically Functionalizing Porous Materials

(75) Inventors: Paula T. Hammond-Cunningham, Newton, MA (US); Kevin C. Krogman, Cambridge, MA (US); Joseph L. Lowery, Midlothian, VA (US); Gregory C. Rutledge, Newton, MA (US)

(73) Assignee: Massachusetts Institute of Technology, Cambridge, MA (US)

(21) Appl. No.: 12/561,757

(22) Filed: Sep. 17, 2009

(51) Int. Cl. B32B 3/26; B05D 5/00; B32B 9/04; B32B 27/06; B32B 27/30; B05D 1/36

(52) U.S. Cl. 428/306.6; 427/243; 428/411.1; 428/473.5; 428/500; 427/402; 427/244

(57) ABSTRACT

One aspect of the invention relates to a method for installing coatings of different morphology and function within a single textile membrane. Remarkably, the methods described herein enable one to engineer the properties of a material at the nanoscopic level and produce the material in commercially viable quantities. For example, by simply controlling the flow rate of charged species passing through an electrospun material during spray-assisted Layer-by-Layer (Spray-LbL) deposition, individual fibers within the matrix can be conformally functionalized for ultra-high surface area catalysis, or bridged to form a networked sublayer with complimentary properties.

### GOVERNMENT SUPPORT

The invention was made with support provided by the U.S. Army under contract DAAD-19-02-0002; the government has certain rights in the invention.

### BACKGROUND

Naturally occurring membranes, such as those found in plants, cell walls and organs, including the epidermis and intestinal wall, derive their ability to segregate two different environments largely from asymmetry established by their protein constituents. Instead of functioning as a uniform barrier, the cross section of these membranes varies according to their purpose, allowing interior and exterior portions of the membrane to serve very different roles.

Segregation of structure is also observed in porous polymer membranes, where a thin effective separation layer is formed at the upstream surface of the membrane, while the bulk material remains porous and less densely packed. Although identical in chemical composition, asymmetric arrangement of the two morphologies provides the membrane with mechanical robustness while separation is regulated predominantly by the thin barrier layer of material near the surface. Aside from mechanical integrity, however, the existing phase inversion techniques used to generate asymmetric polymer membranes do not introduce functional activity to the bulk matrix, thereby underutilizing the full potential of the substrate material.

### SUMMARY

One aspect of the invention relates to a method for developing multiple coatings of differing morphology and function within a single textile membrane. Remarkably, the methods described herein enable one to engineer the properties of a material from the nanoscopic level, and to produce nanoscopically-engineered materials in commercially viable quantities. For example, we have discovered that by varying the flow rate of charged species passing through an electrospun material during spray-assisted Layer-by-Layer deposition (Spray-LbL) individual fibers within the material can be conformally functionalized for ultra-high surface area catalysis, or bridged to form a networked sublayer with complimentary properties. Exemplified herein by the creation of selectively-reactive gas purification membranes, the myriad applications of the methods also include, for example, self-cleaning fabrics, water purification membranes, and protein-functionalized scaffolds for tissue engineering.

One aspect of the invention relates to a multi-functional material, comprising a porous, fibrous substrate, wherein substantially all of the fibers of the substrate are conformally coated with a first layer-by-layer film, and substantially all of the pores in the substrate are at least partially filed with a second layer-by-layer film.

In certain embodiments, the present invention relates to any one of the aforementioned materials, wherein the substrate comprises electrospun fibers.

In certain embodiments, the present invention relates to any one of the aforementioned materials, wherein the substrate comprises electrospun fibers electrospun from polyamides, nylons, polyolefins, polyacetals, polylactides, poly(epsilon-caprolactone) (PCL), poly(lactic acid) (PLA), poly(glycolic acid) (PGA), copolymers poly(lactide-co-glycolide) (PLGA), polyacrylonitriles, polyesters, cellulose, cellulose ethers and esters, polyalkylene sulfides, polyarylene oxides, polysulfones, modified polysulfone polymers, polyethylene, polyacrylonitrile, polypropylene, poly(vinylchloride), polymethylmethacrylate, polystyrene, poly(vinylidene fluoride), poly(vinylidene chloride), polyvinyl halides, polyvinyl esters, polyvinyl ethers, polyvinyl alcohols, polyvinyl sulfates, polyvinyl phosphates, polyvinyl amines, polyimides, polyoxidiazoles, polytriazols, polycarbodiimides, polycarbonates, polyarylates, phenol-formaldehyde resins, melamine-formaldehyde resins, formaldehyde-ureas, ethyl-vinyl acetate copolymers, poly(acrylic acid), poly(N-vinylformamide), polyethylene oxide, poly(meth)acrylamide, poly(hydroxyethyl acrylate), hydroxyethylcellulose, methylcellulose, or combinations thereof.

In certain embodiments, the present invention relates to any one of the aforementioned materials, wherein the substrate comprises electrospun polyamide fibers.

In certain embodiments, the present invention relates to any one of the aforementioned materials, wherein the substrate comprises electrospun nylon-6,6 fibers.

In certain embodiments, the present invention relates to any one of the aforementioned materials, wherein the substrate comprises a woven fabric.

In certain embodiments, the present invention relates to any one of the aforementioned materials, wherein the substrate comprises a metal.

In certain embodiments, the present invention relates to any one of the aforementioned materials, wherein the first layer-by-layer film comprises a cationic polyelectrolyte.

In certain embodiments, the present invention relates to any one of the aforementioned materials, wherein the first layer-by-layer film comprises a cationic polyelectrolyte selected from the group consisting of PDAC, PAMAM (G4), PAH, and LPEI.

In certain embodiments, the present invention relates to any one of the aforementioned materials, wherein the first layer-by-layer film comprises PDAC.

In certain embodiments, the present invention relates to any one of the aforementioned materials, wherein the first layer-by-layer film comprises an anionic metal oxide nanoparticle.

In certain embodiments, the present invention relates to any one of the aforementioned materials, wherein the first layer-by-layer film comprises an anionic metal oxide nanoparticle selected from the group consisting of nanopaticles of TiO₂, Ta₂O₅, Nb₂O₅, ZrO₂, Y₂O₃, Al₂O₃, CeO₂ and SiO₂.

In certain embodiments, the present invention relates to any one of the aforementioned materials, wherein the first layer-by-layer film comprises nanoparticles of TiO₂.

In certain embodiments, the present invention relates to any one of the aforementioned materials, wherein the first layer-by-layer film comprises between about 1 to about 1,000 bilayers.

In certain embodiments, the present invention relates to any one of the aforementioned materials, wherein the first layer-by-layer film comprises between about 1 to about 500 bilayers.

In certain embodiments, the present invention relates to any one of the aforementioned materials, wherein the first layer-by-layer film comprises between about 1 and about 200 bilayers.

In certain embodiments, the present invention relates to any one of the aforementioned materials, wherein the first layer-by-layer film comprises between about 2 and about 100 bilayers.

In certain embodiments, the present invention relates to any one of the aforementioned materials, wherein the first layer-by-layer film comprises between about 5 and about 50 bilayers.

In certain embodiments, the present invention relates to any one of the aforementioned materials, wherein the first layer-by-layer film comprises about 25 bilayers.

In certain embodiments, the present invention relates to any one of the aforementioned materials, wherein the first layer-by-layer film is (PDAC/TiO₂)ₙ; and n is between about 1 to about 1,000.

In certain embodiments, the present invention relates to any one of the aforementioned materials, wherein the first layer-by-layer film is (PDAC/TiO₂)₂₅.

In certain embodiments, the present invention relates to any one of the aforementioned materials, wherein the second layer-by-layer film comprises a cationic polyelectrolyte.

In certain embodiments, the present invention relates to any one of the aforementioned materials, wherein the second layer-by-layer film comprises a cationic polyelectrolyte selected from the group consisting of PDAC, PAMAM (G4), PAH, and LPEI.

In certain embodiments, the present invention relates to any one of the aforementioned materials, wherein the second layer-by-layer film comprises PDAC.

In certain embodiments, the present invention relates to any one of the aforementioned materials, wherein the second layer-by-layer film comprises PAMAM (G4).

In certain embodiments, the present invention relates to any one of the aforementioned materials, wherein the second layer-by-layer film comprises PAH.

In certain embodiments, the present invention relates to any one of the aforementioned materials, wherein the second layer-by-layer film comprises LPEI.

In certain embodiments, the present invention relates to any one of the aforementioned materials, wherein the second layer-by-layer film comprises an anionic polyelectrolyte.

In certain embodiments, the present invention relates to any one of the aforementioned materials, wherein the second layer-by-layer film comprises an anionic polyelectrolyte selected from the group consisting of SPS and PAA.

In certain embodiments, the present invention relates to any one of the aforementioned materials, wherein the second layer-by-layer film comprises SPS.

In certain embodiments, the present invention relates to any one of the aforementioned materials, wherein the second layer-by-layer film comprises PAA.

In certain embodiments, the present invention relates to any one of the aforementioned materials, wherein the second layer-by-layer film comprises between about 1 to about 1,000 bilayers.

In certain embodiments, the present invention relates to any one of the aforementioned materials, wherein the second layer-by-layer film comprises between about 1 to about 500 bilayers.

In certain embodiments, the present invention relates to any one of the aforementioned materials, wherein the second layer-by-layer film comprises between about 1 and about 200 bilayers.

In certain embodiments, the present invention relates to any one of the aforementioned materials, wherein the second layer-by-layer film comprises between about 2 and about 100 bilayers.

In certain embodiments, the present invention relates to any one of the aforementioned materials, wherein the second layer-by-layer film comprises about 100 bilayers.

In certain embodiments, the present invention relates to any one of the aforementioned materials, wherein the second layer-by-layer film comprises about 50 bilayers.

In certain embodiments, the present invention relates to any one of the aforementioned materials, wherein the second layer-by-layer film is (PDAC/SPS)ₙ; and n is about 1 to about 1,000.

In certain embodiments, the present invention relates to any one of the aforementioned materials, wherein the second layer-by-layer film is (PDAC/SPS)₅₀.

In certain embodiments, the present invention relates to any one of the aforementioned materials, wherein the second layer-by-layer film is (PAMAM/PAA)ₙ; and n is about 1 to about 1,000.

In certain embodiments, the present invention relates to any one of the aforementioned materials, wherein the second layer-by-layer film is (PAMAM/PAA)₅₀.

In certain embodiments, the present invention relates to any one of the aforementioned materials, wherein the second layer-by-layer film is (PAMAM/PAA)₁₀₀.

In certain embodiments, the present invention relates to any one of the aforementioned materials, wherein the second layer-by-layer film is (PAH/PAA)ₙ; and n is between about 1 to about 1,000.

In certain embodiments, the present invention relates to any one of the aforementioned materials, wherein the second layer-by-layer film is (PAH/PAA)₁₀₀.

In certain embodiments, the present invention relates to any one of the aforementioned materials, wherein the second layer-by-layer film is (LPEI/PAA)ₙ; and n is between about 1 to about 1,000.

In certain embodiments, the present invention relates to any one of the aforementioned materials, wherein the second layer-by-layer film is (LPEI/PAA)₁₀₀.

In certain embodiments, the present invention relates to any one of the aforementioned materials, wherein said material is a selectively-reactive gas purification membrane, a self-cleaning fabric, a material used for water purification, or a protein functionalization scaffold used for tissue engineering.

In certain embodiments, the present invention relates to any one of the aforementioned materials, wherein said material is a selectively-reactive gas purification membrane.

Another aspect of the invention relates to a method of fabricating a multi-functional material from a porous, fibrous substrate comprising the steps of: alternatingly depositing a first material and a second material on a porous, fibrous substrate, thereby conformally coating the fibers of the substrate with a first layer-by-layer film; and alternatingly depositing a third material and a fourth material on the conformally coated substrate, thereby at least partially filling the pores in the substrate with a second layer-by-layer film.

In certain embodiments, the present invention relates to any one of the aforementioned methods, wherein the substrate is inherently charged.

In certain embodiments, the present invention relates to any one of the aforementioned methods, wherein the substrate comprises electrospun fibers.

In certain embodiments, the present invention relates to any one of the aforementioned methods, wherein the substrate comprises electrospun fibers electrospun from polyamides, nylons, polyolefins, polyacetals, polylactides, poly(epsilon-caprolactone) (PCL), poly(lactic acid) (PLA), poly(glycolic acid) (PGA), copolymers poly(lactide-co-glycolide) (PLGA), polyacrylonitriles, polyesters, cellulose, cellulose ethers and esters, polyalkylene sulfides, polyarylene oxides, polysulfones, modified polysulfone polymers, polyethylene, polyacrylonitrile, polypropylene, poly(vinylchloride), polymethylmethacrylate, polystyrene, poly(vinylidene fluoride), poly(vinylidene chloride), polyvinyl halides, polyvinyl esters, polyvinyl ethers, polyvinyl alcohols, polyvinyl sulfates, polyvinyl phosphates, polyvinyl amines, polyimides, polyoxidiazoles, polytriazols, polycarbodiimides, polycarbonates, polyarylates, phenol-formaldehyde resins, melamine-formaldehyde resins, formaldehyde-ureas, ethyl-vinyl acetate copolymers, poly(acrylic acid), poly(N-vinylformamide), polyethylene oxide, poly(meth)acrylamide, poly(hydroxyethyl acrylate), hydroxyethylcellulose, methylcellulose, or combinations thereof.

In certain embodiments, the present invention relates to any one of the aforementioned methods, wherein the substrate comprises electrospun polyamide fibers.

In certain embodiments, the present invention relates to any one of the aforementioned methods, wherein the substrate comprises electrospun nylon-6,6 fibers.

In certain embodiments, the present invention relates to any one of the aforementioned methods, wherein the substrate comprises a woven fabric.

In certain embodiments, the present invention relates to any one of the aforementioned methods, wherein the substrate is a metal.

In certain embodiments, the present invention relates to any one of the aforementioned methods, wherein the first layer-by-layer film is deposited by a spray assisted layer-by-layer process.

In certain embodiments, the present invention relates to any one of the aforementioned methods, wherein the spray assisted layer-by-layer process comprises the steps of spraying a first material from a first distance, at a first rate, for a first time, onto the substrate; and spraying a second material from a second distance, at a second rate, for a second time, onto the substrate.

In certain embodiments, the present invention relates to any one of the aforementioned methods, wherein the first distance is between about 0.01 cm and 100 cm. In certain embodiments, the present invention relates to any one of the aforementioned methods, wherein the first rate is between about 0.01 mL/sec and 1 mL/sec. In certain embodiments, the present invention relates to any one of the aforementioned methods, wherein the first time is between about 1 sec and 60 sec.

In certain embodiments, the present invention relates to any one of the aforementioned methods, wherein the second distance is between about 0.01 cm and 100 cm. In certain embodiments, the present invention relates to any one of the aforementioned methods, wherein the second rate is between about 0.01 mL/sec and 1 mL/sec. In certain embodiments, the present invention relates to any one of the aforementioned methods, wherein the second time is between about 1 sec and 60 sec.

In certain embodiments, the present invention relates to any one of the aforementioned methods, wherein the spray assisted layer-by-layer process further comprises the step of imposing a pressure gradient across the substrate while the fibers in the substrate are conformally coated with the first layer-by-layer film.

In certain embodiments, the present invention relates to any one of the aforementioned methods, wherein the pressure gradient results in a flow of the first material through the pores of the substrate; and the flow of the first material has a Reynolds (Re) number of between about 1 and about 6.

In certain embodiments, the present invention relates to any one of the aforementioned methods, wherein the pressure gradient results in a flow of the second material through the pores of the substrate; and the flow of the second material has a Reynolds (Re) number of between about 1 and about 6. In certain embodiments, the present invention relates to any one of the aforementioned methods, wherein the first layer-by-layer process further comprises a step of rinsing the substrate with water between the step of spraying the first material onto the substrate and the step of spraying the second material onto the substrate.

In certain embodiments, the present invention relates to any one of the aforementioned methods, wherein the first layer-by-layer film comprises a cationic polyelectrolyte.

In certain embodiments, the present invention relates to any one of the aforementioned methods, wherein the first layer-by-layer film comprises cationic a polyelectrolyte selected from the group consisting of PDAC, PAMAM (G4), PAH, and LPEI.

In certain embodiments, the present invention relates to any one of the aforementioned methods, wherein the first layer-by-layer film comprises PDAC.

In certain embodiments, the present invention relates to any one of the aforementioned methods, wherein the first layer-by-layer film comprises an anionic metal oxide nanoparticle.

In certain embodiments, the present invention relates to any one of the aforementioned methods, wherein the first layer-by-layer film comprises an anionic metal oxide nanoparticle selected from the group consisting of nanopaticles of TiO₂, Ta₂O₅, Nb₂O₅, ZrO₂, Y₂O₃, Al₂O₃, CeO₂ and SiO₂.

In certain embodiments, the present invention relates to any one of the aforementioned methods, wherein the first layer-by-layer film comprises a nanoparticle of TiO₂.

In certain embodiments, the present invention relates to any one of the aforementioned methods, wherein the first layer-by-layer film comprises between about 1 and about 1,000 bilayers.

In certain embodiments, the present invention relates to any one of the aforementioned methods, wherein the first layer-by-layer film comprises between about 1 and about 500 bilayers.

In certain embodiments, the present invention relates to any one of the aforementioned methods, wherein the first layer-by-layer film comprises between about 1 and about 200 bilayers.

In certain embodiments, the present invention relates to any one of the aforementioned methods, wherein the first layer-by-layer film comprises between about 2 and about 100 bilayers.

In certain embodiments, the present invention relates to any one of the aforementioned methods, wherein the first layer-by-layer film comprises between about 5 and about 50 bilayers.

In certain embodiments, the present invention relates to any one of the aforementioned methods, wherein the first layer-by-layer film comprises about 25 bilayers.

In certain embodiments, the present invention relates to any one of the aforementioned methods, wherein the first layer-by-layer film comprises alternating layers of cationic polymers and anionic metal-oxide nanoparticles.

In certain embodiments, the present invention relates to any one of the aforementioned methods, wherein the first layer-by-layer film is (PDAC/TiO₂)ₙ; and n is between about 1 and about 1,000.

In certain embodiments, the present invention relates to any one of the aforementioned methods, wherein the first layer-by-layer film is (PDAC/TiO₂)₂₅.

In certain embodiments, the present invention relates to any one of the aforementioned methods, wherein the second layer-by-layer film is deposited by a spray assisted layer-by-layer process.

In certain embodiments, the present invention relates to any one of the aforementioned methods, wherein the spray assisted layer-by-layer process comprises the steps of spraying a third material from a third distance, at a third rate, for a third time, onto the conformally coated substrate; and spraying a fourth material from a fourth distance, at a fourth rate, for a fourth time, onto the conformally coated substrate.

In certain embodiments, the present invention relates to any one of the aforementioned methods, wherein the third distance is between about 0.01 cm and 100 cm. In certain embodiments, the present invention relates to any one of the aforementioned methods, wherein the third rate is between about 0.01 mL/sec and 1 mL/sec. In certain embodiments, the present invention relates to any one of the aforementioned methods, wherein the third time is between about 1 sec and 60 sec.

In certain embodiments, the present invention relates to any one of the aforementioned methods, wherein the fourth distance is between about 0.01 cm and 100 cm. In certain embodiments, the present invention relates to any one of the aforementioned methods, wherein the fourth rate is between about 0.01 mL/sec and 1 mL/sec. In certain embodiments, the present invention relates to any one of the aforementioned methods, wherein the fourth time is between about 1 sec and 60 sec.

In certain embodiments, the present invention relates to any one of the aforementioned methods, wherein the second layer-by-layer film comprises a cationic polyelectrolyte.

In certain embodiments, the present invention relates to any one of the aforementioned methods, wherein the second layer-by-layer film comprises a cationic polyelectrolyte selected from the group consisting of PDAC, PAMAM (G4), PAH, and LPEI.

In certain embodiments, the present invention relates to any one of the aforementioned methods, wherein the second layer-by-layer film comprises PDAC.

In certain embodiments, the present invention relates to any one of the aforementioned methods, wherein the second layer-by-layer film comprises PAMAM (G4).

In certain embodiments, the present invention relates to any one of the aforementioned methods, wherein the second layer-by-layer film comprises PAH.

In certain embodiments, the present invention relates to any one of the aforementioned methods, wherein the second layer-by-layer film comprises LPEI.

In certain embodiments, the present invention relates to any one of the aforementioned methods, wherein the second layer-by-layer film comprises an anionic polyelectrolyte.

In certain embodiments, the present invention relates to any one of the aforementioned methods, wherein the second layer-by-layer film comprises an anionic polyelectrolyte selected from the group consisting of SPS and PAA.

In certain embodiments, the present invention relates to any one of the aforementioned methods, wherein the second layer-by-layer film comprises SPS.

In certain embodiments, the present invention relates to any one of the aforementioned methods, wherein the second layer-by-layer film comprises PAA.

In certain embodiments, the present invention relates to any one of the aforementioned methods, wherein the second layer-by-layer film comprises between about 1 and about 1,000 bilayers.

In certain embodiments, the present invention relates to any one of the aforementioned methods, wherein the second layer-by-layer film comprises between about 1 and about 500 bilayers.

In certain embodiments, the present invention relates to any one of the aforementioned methods, wherein the second layer-by-layer film comprises between about 1 and about 200 bilayers.

In certain embodiments, the present invention relates to any one of the aforementioned methods, wherein the second layer-by-layer film comprises between about 2 and about 100 bilayers.

In certain embodiments, the present invention relates to any one of the aforementioned methods, wherein the second layer-by-layer film comprises about 100 bilayers.

In certain embodiments, the present invention relates to any one of the aforementioned methods, wherein the second layer-by-layer film comprises about 50 bilayers.

In certain embodiments, the present invention relates to any one of the aforementioned methods, wherein the second layer-by-layer film is (PDAC/SPS)ₙ; and n is about 1 to about 1,000. In certain embodiments, the present invention relates to any one of the aforementioned methods, wherein the second layer-by-layer film is (PDAC/SPS)₅₀.

In certain embodiments, the present invention relates to any one of the aforementioned methods, wherein the second layer-by-layer film is (PAMAM/PAA)ₙ; and n is about 1 to about 1,000. In certain embodiments, the present invention relates to any one of the aforementioned methods, wherein the second layer-by-layer film is (PAMAM/PAA)₅₀.

In certain embodiments, the present invention relates to any one of the aforementioned methods, wherein the second layer-by-layer film is (PAMAM/PAA)₁₀₀.

In certain embodiments, the present invention relates to any one of the aforementioned methods, wherein the second layer-by-layer film is (PAH/PAA)ₙ; and n is about 1 to about 1,000. In certain embodiments, the present invention relates to any one of the aforementioned methods, wherein the second layer-by-layer film is (PAH/PAA)₁₀₀.

In certain embodiments, the present invention relates to any one of the aforementioned methods, wherein the second layer-by-layer film is (LPEI/PAA)ₙ; and n is about 1 to about 1,000₀. In certain embodiments, the present invention relates to any one of the aforementioned methods, wherein the second layer-by-layer film is (LPEI/PAA)₁₀₀.

In certain embodiments, the present invention relates to any one of the aforementioned methods, wherein the substrate has a first side and a second side; the first layer-by-layer film is deposited by a spray assisted layer-by-layer process applied to the first side of the substrate; and the second layer-by-layer film is deposited by a spray assembly layer-by-layer process applied to the second side of the substrate.

In certain embodiments, the present invention relates to any one of the aforementioned methods, wherein said material is a selectively-reactive gas purification membrane, a self-cleaning fabric, a material used for water purification, or a protein functionalization scaffold used for tissue engineering.

In certain embodiments, the present invention relates to any one of the aforementioned methods, wherein said material is a selectively-reactive gas purification membrane.

Another aspect of the invention relates to a material made by any one of the aforementioned methods.

### BRIEF DESCRIPTION OF THE FIGURES

FIG. 1 depicts a multi-functionalization process on electrospun mats. a, parallel plate electrospinning technique (diagram, left) is used to create nylon-6,6 electrospun mats of 8-10 inch diameter (right), represented schematically in b, and with top-down (center column) and cross-sectional (far right) SEM micrographs. c, the technique of spraying in concert with a pressure gradient across the mat is demonstrated to create (PDAC/TiO₂)₂₅ conformal coatings on individual fibers. Conformal coatings are of uniform cross-section independent of spray direction, and smoothly coat the length of the fibers. d, spraying in the absence of a pressure gradient to deposit (PDAC/SPS)₅₀ coating bridges pores on the mat surface. Heavy bridging occurs after relatively few deposition cycles, and can be performed using a variety of charged species to affect functionality of the final membrane.

FIG. 2 depicts diagrams and graphs illustrating the growth mechanism as a function of flow rate past electrospun fibers. a, For packed bed Reynolds numbers Re_{d}=(D*Vₛ)/((1−ε)*v>6 (where D is the average fiber diameter, Vₛ is the superficial fluid velocity, ε=0.85 is the void fraction of the electrospun mat, and v=15.7×10⁻⁶ m²/s is the kinematic viscosity of air at 300 K) flow separation of the streamlines from the back side of the fiber occurs. At these fluid velocities (SEM taken for Re_{d} of about 6.5) LbL deposition is only observed to occur near the leading edge stagnation point on the fibers. b, As the velocity is decreased and Re_{d} becomes subcritical, the absence of flow separation allows viscous forces to uniformly deposit polyelectrolyte molecules evenly around the fiber circumference (cross-sectional SEM taken at a Re_{d} of about 1.7). c, the growth profile observed for (PDAC/TiO₂)ₙ deposited on planar silicon is plotted in blue, and indicates a rate of 9.6 nm per cycle. Assuming conformal growth is due to a similar mechanism for a Re_{d} less than 6, the expected incremental increase in average fiber diameter is plotted in red starting from the observed initial fiber diameter. Average fiber diameter (top line) is expected to grow twice as rapidly as a planar film (bottom line) since the deposited layer is counted twice, once from each side of the fiber, by this measurement. Remarkable agreement is observed for the empirical mean and standard deviation of electrospun fibers treated with (PDAC/TiO₂)₂₅, plotted in green.

FIG. 3 depicts the entire cross-section of a multi-functionalized electrospun membrane. An electrospun nylon sample which has been treated with (PDAC/TiO₂)₂₅ in the presence of a pressure gradient to create a high surface area photocatalytic region, followed by (PAMAM/PAA)₅₀ treatment in the absence of a gradient to create a chloroethyl ethyl sulfide (CEES) transport barrier can be seen in its entirety. Roughly 10% (˜30 μm) of the membrane near the surface is responsible for regulating mass transport, while the remainder of the membrane is free to act as a high surface area scaffold for photocatalysis as well as mechanical support for the relatively thin barrier region. Flux can be closely controlled by tuning the content and thickness of the barrier region, producing an optimal residence time for catalytic degradation to occur.

FIG. 4 depicts chloroethyl ethyl sulfide (CEES) permeation test results. An electrospun nylon sample is treated with (PDAC/TiO₂)₂₅ Al2O ng with a pressure gradient to create a high surface area photocatalytic region, followed by (PAMAM/PAA)₅₀ in the absence of a gradient to create a barrier to CEES transport. Upon exposure to 3 μL of CEES the mass flux of CEES across the membrane and into the sweep gas is observed in the presence of UV light as well as in the dark. In both cases a time-lag of 60-90 seconds is observed during which the vapor sample is in the capillary of the test system but has not yet reached the detector. Net permeation over the duration of the test is reduced by more than 74% in the presence of UV light while peak flux occurs earlier in the test when compared to the dark scenario. This behavior is attributed to UV absorption, localized heating and material expansion of the thin barrier film restricting CEES permeation.

FIG. 5 tabulates data regarding the permeability to chloroethyl ethyl sulfide (CEES) and water vapors shown by various multi-functionalized samples. Water vapor flux and photocatalytic capability of several untreated (2 and 8), photocatalytically functionalized (1, 3 and 4), and multiply functionalized (5, 6 and 7) samples were measured. Each surface area range represents values collected from three separate samples deposited from independent solutions. Samples 5 and 6 demonstrate the advantages of conformal TiO₂ treatment as well as pore bridging on available surface area and permeation characteristics. The dramatic increase in surface area observed when as-spun nylon fibers were conformally treated with (PDAC/TiO₂)₂₅ coatings did not translate into increased photocatalytic ability until a barrier layer was added, mitigating vapor phase diffusion through the membrane and increasing the residence time for reaction to occur.

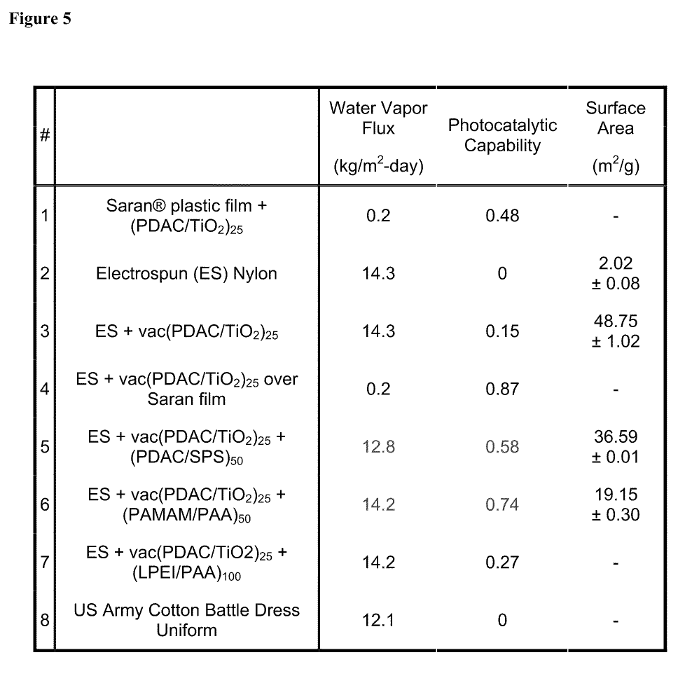

FIG. 6 depicts a graph showing the observed trade-off between reactive properties and water vapor transport rates. The data shown in the graph is the data tabulated in FIG. 5. Traditionally, effective barrier materials (1 and 4) do not possess the high selectivity necessary to discern between water molecules and contaminant molecules, thus sacrificing water vapor permeability in an effort to limit toxic molecule permeation. Alternatively, highly porous materials (2 and 8) readily permit water vapor transport, but provide little resistance to hazardous vapors. Multiply functionalized electrospun materials (5, 6 and 7) are able to act as tunable asymmetric membranes to optimize the residence time of toxic vapors in the reactive portion of the membrane, improving photocatalytic activity without sacrificing water vapor permeability.

FIG. 7 depicts chloroethyl ethyl sulfide (CEES) flux as a function of time for (PAMAM/PAA)₁₀₀ at various pHs. Cumulative flux data has been tabulated by collecting instantaneous flux data and integrating over time. As the instantaneous flux profile approaches a steady state value the cumulative flux profile becomes linear. Regressing this line to the x-axis yields a time-lag value which is used to calculate the diffusivity of CEES through the (PAMAM/PAA)₁₀₀ films. Using this method, the longest lag time occurs for the film assembled at pH 4 (τ_{lag}=3784 s), which can be attributed primarily to the thick film generated when PAA is only weakly charged, but PAMAM (both 1° and 3° amines) is highly charged. Because it is less densely ionically cross-linked this film also shows a comparatively large diffusivity value.

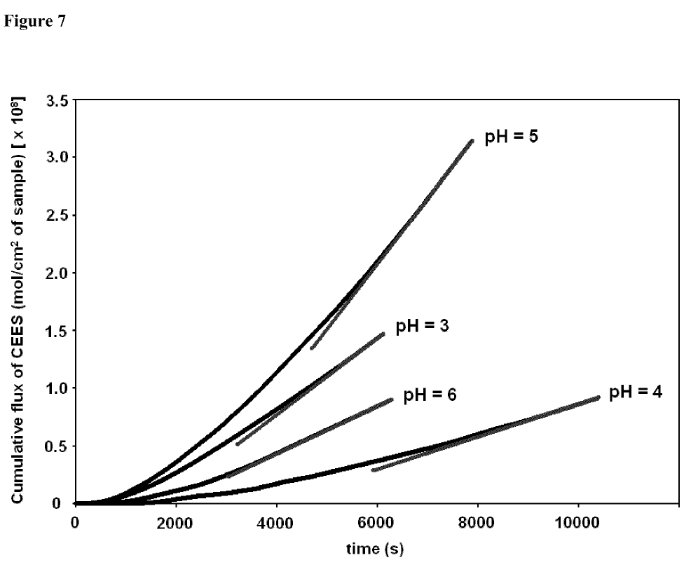

FIG. 8 depicts the permeability, diffusivity and solubility of chloroethyl ethyl sulfide (CEES) measured for four LbL films deposited over a range of pH values. Permeability data has been collected using a specially designed cell for four LbL systems deposited at pH=3, 4, 5, and 6 on microporous polycarbonate track etched membranes, and plotted as instantaneous flux as well as cumulative flux over time. The steady state plateau obtained from the plot of instantaneous flux versus time is used to calculate the permeability through the film, while the diffusivity is calculated using the time-lag method (FIG. 7). By extrapolating the linear portion of the cumulative flux versus time plot back to the x-axis intercept a time-lag equal to the film thickness squared over six times the diffusivity can be found. The solubility is then calculated as the ratio of the permeability and the diffusivity. This type of analysis presents vital engineering properties of the materials that give insight into why a material is an effective barrier. Solubility values reflect the energetic favorability of allowing a solute molecule into the polymer matrix, while diffusivity values quantify the architectural barriers to mass transfer. As a result, two materials can demonstrate very similar permeability values, such as (LPEI/PAA)ₙ and (PAH/PAA)ₙ, for different reasons.

FIG. 9 depicts Energy Dispersive X-ray (EDX) elemental analysis data. EDX data collected using a 10 keV beam potential from, a, the bridged surface of the mat, indicating the presence of titanium, from the TiO₂, and sulfur, from SPS in the bridged layer. b, Data collected from deeper within the treated electrospun mat indicates a similar level of titanium but very little sulfur, suggesting TiO₂ has been deposited throughout the mat while the (PDAC/SPS)ₙ treatment has been restricted to the surface in the absence of a pressure gradient during deposition. Samples were first sputtered with an Au—Pd coating in preparation for microscopy, thus the gold peak's presence in both scans. c, Further EDX mapping (at reduced voltage to minimize sample deterioration during the prolonged time required for elemental mapping) again indicates the presence of titanium throughout the mat cross-section. The blotchy image is due to reduced map resolution chosen to minimize sampling time and reduce destructive charging.

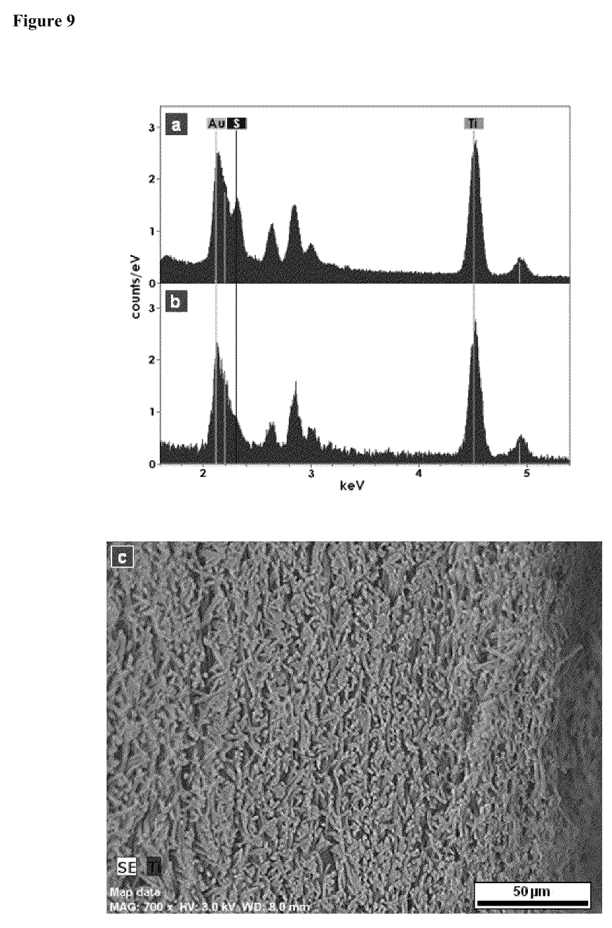

FIG. 10 depicts chloroethyl ethyl sulfide (CEES) permeation test results. Two electrospun nylon samples were treated with (PDAC/TiO₂)₂₅ Al2O ng with a pressure gradient to create a high surface area photocatalytic region. One sample is subsequently treated with (PAMAM/PAA)₅₀ in the absence of a gradient to create a barrier to CEES transport. Upon exposure to 3 μL of CEES the mass flux of CEES across each membrane and into the sweep gas is recorded for both samples in the dark. In the absence of UV degradation the net flux remains the same over the duration of either test, but a reduction in peak flux, by roughly 56%, is observed when the bridged layer is in place. This reduction in peak flow rate increases the residence time of CEES in the photocatalytic region of the mat and increases photocatalytic degradation.

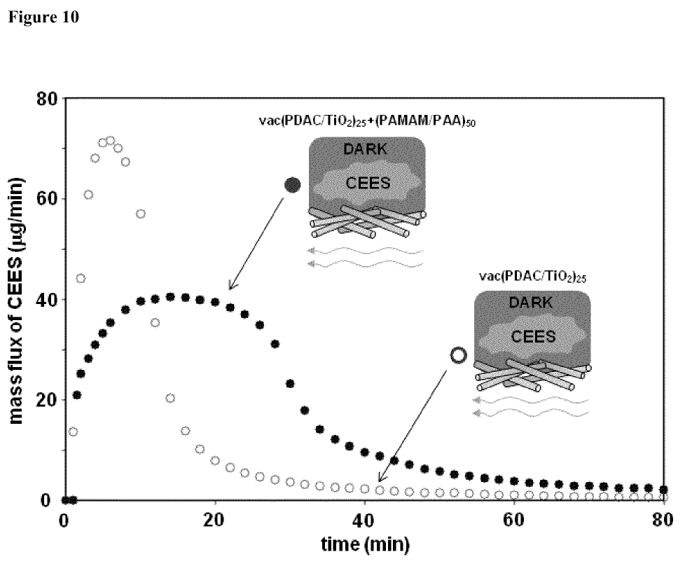

FIG. 11 depicts the chemical structure of exemplary polyelectrolytes that can be deposited by the Layer-by-Layer process. Anionic species, a, poly(sodium 4-styrenesulfonate), SPS (1,000,000 MO, and b, poly(acrylic acid) sodium salt, PAA (15,000 MO, as well as cationic species, c, poly(diallyldimethylammonium chloride), PDAC (150,000 MO, d, poly(amidoamine) dendrimer, PAMAM (G4, but drawn here as G2 for clarity), and e, linear poly(ethyleneimine), LPEI (25,000 M_{w}.

### DETAILED DESCRIPTION

Disclosed is a process that enables distinct flow rate-dependent modes of electrostatic deposition, by which multiple functionalities can be introduced into a single engineered textile. Similar to the way many naturally occurring membranes simultaneously regulate mass transfer and undergo chemical reactions with solute molecules, the techniques disclosed herein allow portions of a coated substrate to act as an inert barrier while the bulk material acts as a high surface area scaffold capable of supporting a wide variety of functionalities.

One aspect of the invention relates to the use of Layer-by-Layer (LbL) assembly techniques for the deposition of ultrathin uniform films via the sequential electrostatic deposition of charged polymers, nanoparticles, biological templates, and/or biologically active species. For example, an inherently charged substrate is serially exposed to solutions of oppositely charged species, which adsorb to the developing film at rates that allow nanometer-scale control of the film's thickness.

In certain embodiments, the LbL assembly comprises spraying solutions of charged species onto a desired substrate (Spray-LbL). Similar to the traditional dipping process, assembly occurs via electrostatic interactions between areas of local charge density on oppositely charged species, but process times can be reduced more than twenty-five fold by convectively transporting charged species to the surface. Planar non-porous substrates, such as silicon and glass, are readily coated by either technique and, when exposed to similar solutions, exhibit ostensibly similar growth rates and final film properties.

In certain embodiments, the substrate coated is an electrospun fiber. The electrospun fibers enable the generation of porous polymer scaffolds which can be tuned for fiber size and surface area and chemically modified using a number of methods. By drawing a pressure gradient across porous substrates during the Spray-LbL process, it has been found that highly conformal coatings can be developed on individual fibers, wires, or pores throughout the thickness of the bulk porous substrate. This process retains the flexibility, speed and ambient processing conditions that make Spray-LbL an attractive deposition technique, and is capable of creating exceptionally high surface area coatings; applications of relevance include, for example, fabrication of self-cleaning photocatalytic membranes, conformal surface passivation for corrosion protection, or fabrication of biocatalytic membranes for pharmaceutical or biofuel applications.

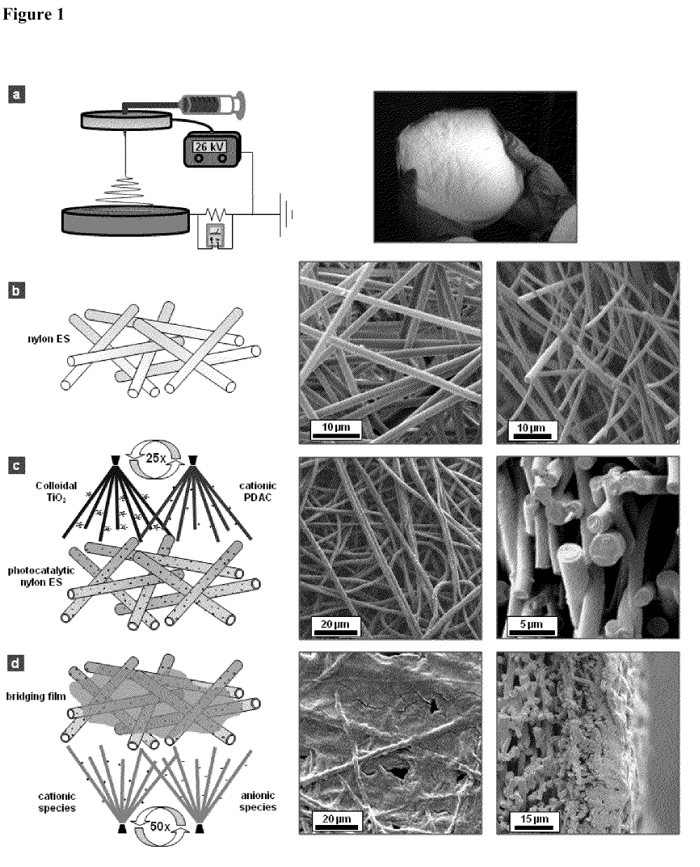

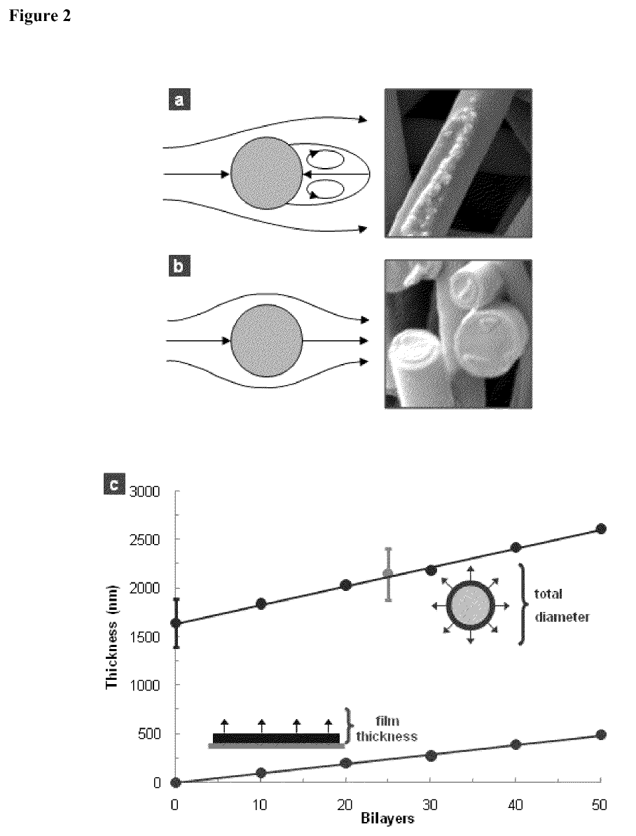

In order to demonstrate the conformal coating of individual fibers within a material, parallel plate electrospinning was used to create flexible nonwoven mats of microscale nylon-6,6 fibers (D=1.64±0.25 μm), from hexafluoroisopropanol solutions (FIGS. 1a-b). Selecting poly(dimethyldiallylammonium chloride) (PDAC) as the cationic species and amphoteric titanium dioxide nanoparticles (which have been synthesized at a pH above the isoelectric point) as the anionic species, a sprayed deposition can be performed. Chosen for its photocatalytic capabilities, this system presents an ideal candidate for catalysis applications by implementing a surface coating on a high surface area scaffold. Imposing a pressure gradient across the electrospun material during the deposition generates a controllable convective flow rate which was found to have a profound effect on the geometry of the developing film. Recalling Re_{d} is equal to about 6 as the critical diameter-based Reynolds number for flow separation from the downstream side of a cylinder, surprising agreement with the correlation is observed. At Re_{d} equal to 6.5 film growth is observed only near the stagnation point on the front of the cylindrical fibers (FIG. 2a); however as Re_{d} becomes sub-critical, uniform coatings develop conformally on individual fibers within the mat (FIG. 2b). The coating does not exhibit preference toward the direction of flow (FIG. 1c), but grows linearly (FIG. 2c) at rates similar to those observed on planar substrates (9.6 nm/cycle). This result indicates that viscous forces are responsible for species deposition, not line-of-sight impact as observed at higher Re_{d} values. Furthermore, based on the Spray-LbL technique, conformal coatings can be created rapidly and uniformly even on large substrate areas using this technique. From electron microscopy, it is clear that the nanofibers are each individually coated with a concentric and uniform shell of polymer multilayer, and that the shell is of consistent thickness independent of fiber diameter or position within the electrospun cross-section (about 0.5 mm thick).

In the absence of a pressure gradient (i.e., Re_{d} is 0) the conformally coated mats can be further processed using the same Spray-LbL technique. Instead of convectively penetrating into the electrospun matrix, polyelectrolyte chains arriving at the material's surface begin to fill the gaps between fibers. As serial deposition continues the coating grows laterally, filling interstitial voids (also referred to herein as “pores”). After only 50 sequential alternations between the cationic species PDAC and a suitably strong polyelectrolyte anionic species, such as poly(sodium 4-styrenesulfonate) (SPS), the bridging of surface voids is nearly complete (FIG. 1d). Remarkably, polyelectrolytes with hydrodynamic sizes on the order of 50 nm are able to occlude 10-20 μm gaps between fiber supports; however, without a convective force driving polyelectrolyte transport throughout the porous network, surface fibers act as an electrostatic net catching the about 5 μm droplets between nearby fibers via favorable interfacial interactions. Fiber spanning ensues, and bridges efficiently build across the larger pores as the LbL cycle is repeated. As a result penetration is restricted to 20-30 μm at the surface of the nylon matrix. It should be noted that it is believed that the geometry of the electrospun material plays a crucial role in the bridging process as well. In this demonstration impinging droplets of solution are of similar order of magnitude in size compared to the inter-fiber voids, and vary in charge density. At this scale fluidic properties, such as solid-liquid contact, may play an equally important role as electrostatics during the bridging process.

The flexibility of the method is further demonstrated by extending the choice of bridging materials to include polyelectrolyte solutions at pH values drastically different than pH 10, at which (PDAC/TiO₂)ₙ deposition was conducted. With reference to the previous example, when (PDAC/SPS) is replaced by the polyelectrolyte system poly(amidoamine) (PAMAM) and poly(acrylic acid) (PAA) titrated to pH 4, the conformal (PDAC/TiO₂) coating remained intact and unaffected. Prolonged exposure to pH 4 solutions in traditional LbL dipping baths would normally lead to loss of ionization of titania nanoparticles (pI is 6), exfoliation and eventual deconstruction and destabilization of (PDAC/TiO₂)ₙ coatings, severely restricting the range of available pH conditions for processing. The Spray-LbL process is significantly more rapid, and the treated mat is never subjected to prolonged soak exposure times at potentially unfavorable pH, lending greater flexibility to the range of coatings which can be applied to the same substrate sample.

This technique provides many advantages to material design and engineering. For example, the application of multi-functionalized electrospun mats as self-cleaning materials that can provide toxic chemical protection to the wearer while maintaining comfort and breathability in the form of water vapor permeability has been investigated. The goal of this application is to engineer a selectively reactive membrane with tunable mass transfer properties. Deposited as described above, the conformal application of a photocatalytic film in the presence of a pressure gradient (hereon written vac(PDAC/TiO₂)₂₅) onto the fibers of an electrospun nylon mat increases the active surface area of smooth as-spun fibers from 2.02 to 48.75 m²/g as determined by BET surface area analysis. BET-determined values were consistently found to be within 10% of those calculated via SEM measurements and the geometric relationship (Eq. 1) for untreated as-spun samples of both nylon and poly(ε-caprolactone):

$$\frac{{A}_{surface}}{mass} = \frac{2}{{R}_{fiber} {ρ}_{material}} \qquad ( 1 )$$

The 25-fold increase in surface area is directly due to the conformal coating, the outermost surface layer of which is nanoparticles as the LbL spray sequence concludes with the anionic species (in this case colloidal TiO₂), now encasing the smooth fibers originally generated during the electrospinning process. Treated samples were subjected to photocatalytic testing by mounting the mat in between a sealed vapor space containing a saturated vapor of chloroethyl ethyl sulfide (CEES), a simulant for the chemical warfare agent HD mustard gas, and a stream of clean air. By comparing the flux of CEES in the air stream with and without UV irradiation on the sample, the photocatalytic capability of the treated material can be quantified (Eq. 2):

$$capability = 1 - \frac{{\int }_{{t}_{0}}^{{t}_{∞}} {[ permeant ]}_{UV} d t}{{\int }_{{t}_{0}}^{{t}_{∞}} {[ permeant ]}_{dark} d t} \qquad ( 2 )$$

where the permeant concentrations refer to the concentration of CEES in the air stream below the sample. An ideal sample will have a photocatalytic capability of 1.0, as the net flux of CEES during the UV illuminated test approaches zero, whereas a material with no photocatalytic capability will rate 0.0. Electrospun nylon treated with vac(PDAC/TiO₂)₂₅ exhibits high surface area for catalytic reaction, degrading 15% of the CEES dosage when exposed to UV light, but the reaction remains rate limited by the rate of adsorption of CEES onto the fiber surfaces, allowing significant amounts of CEES contaminant to move diffusively through the highly porous mat.

To confirm that TiO₂ is necessary for CEES degradation a negative control test using untreated Nylon under UV light was conducted. This test also served as a leak control test of the permeation cell. The integrals in the numerator and denominator of the “photocatalytic capability” calculation were within 2% of each other, confirming the reproducibility of the test process as well as the necessity of TiO₂ in the degradation process.

Placing the functionalized electrospun material in series with a nonporous barrier material, such as Saran® 8 (a biaxially oriented monolayer film of poly(vinylidene chloride)), eliminates rapid vapor diffusion through the matrix. Acting as diffusive resistance and restricting mass transfer, Saran® increased the residence time of CEES molecules in the photocatalytic matrix. Consequently, the observed photocatalytic capability increases to 87%. This scenario illustrates the traditional trade-off of chem-protective materials: chemical barriers suppress toxic chemical penetration, but in the process suppress transport of other small molecules, such as water vapor. Electrospun nylon+vac(PDAC/TiO₂)₂₅ is highly porous and allows water vapor flux at 14.3 kg/m²-day, but is only able to degrade 15% of a saturated CEES dosage. Placing it in series with a Saran® barrier significantly increases the catalytic residence time, but in order to achieve the resultant 87% CEES deactivation, the water vapor flux is decreased by 99%.

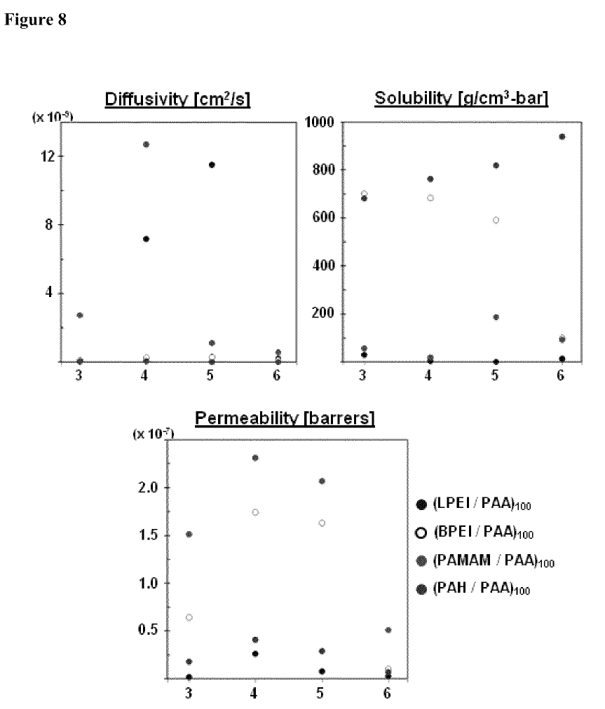

The Spray-LbL platform enables the application of a mass transfer limiting “barrier” layer with controllable properties and thickness directly onto the functionalized membrane using electrostatic assembly of hydrophilic polyelectrolytes. To establish a basis by which polyelectrolyte multilayers form an effective barrier layer, the mass transfer properties of four weak polyelectrolyte systems were evaluated by spraying non-porous films on microporous polycarbonate substrates. Weak polyelectrolytes vary their degree of ionization as a function of solution pH, presenting a means to manipulate the effective ionic crosslinking of the film as well as the chemical composition independently to tune permeation of CEES molecules through the matrix. Using the time-lag method to describe solution-diffusion mass transfer of solute molecules through a non-porous material, permeability values were collected for the four polyelectrolyte systems deposited over a range of pH values (FIG. 8). Using this technique, the permeability can be broken down into a solubility contribution and a diffusivity contribution. The solubility contribution in LbL films can be interpreted as the relative ease with which solute molecules interact with chemical species present in the polymer film as they traverse the film. The diffusivity contribution reflects the molecular scale mobility of CEES in the coating.

Increased solubility occurs when the energy associated with introducing a solute molecule into the polymer matrix is low, and decreased diffusivity is observed as the charged nature of the polyelectrolyte constituents increases leading to a more densely crosslinked electrostatic thin film. For example, films deposited from the weak polycation poly(allylamine hydrochloride) (PAH) and the weak polyanion PAA over the pH range 4-8 exhibit very similar CEES permeability values to those observed from films of poly(ethyleneimine) (LPEI) and PAA, but for very different reasons. PAH is highly charged below its pKₐ (about 8.5) generating more densely crosslinked films, and lower diffusivities, than those created from LPEI (pKₐ of about 5.5) for the pH range in question. Similarly, CEES molecules interact more favorably with primary amine groups present in (PAH/PAA)ₙ films than secondary amines present in (LPEI/PAA)ₙ films, leading to significantly higher solubility values. The net effect on permeability appears quantitatively similar, but the insight gained by separating the permeability into solubility and diffusivity contributions is invaluable. In an effort to facilitate water vapor transport while retarding CEES transport, it is necessary to form a mass transfer-limiting surface layer bridging the network of fibers using polyelectrolyte systems that specifically exhibit low CEES solubility values.

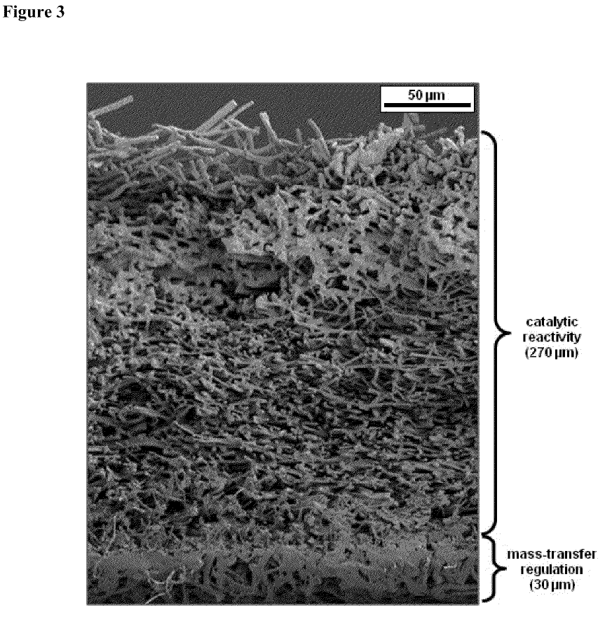

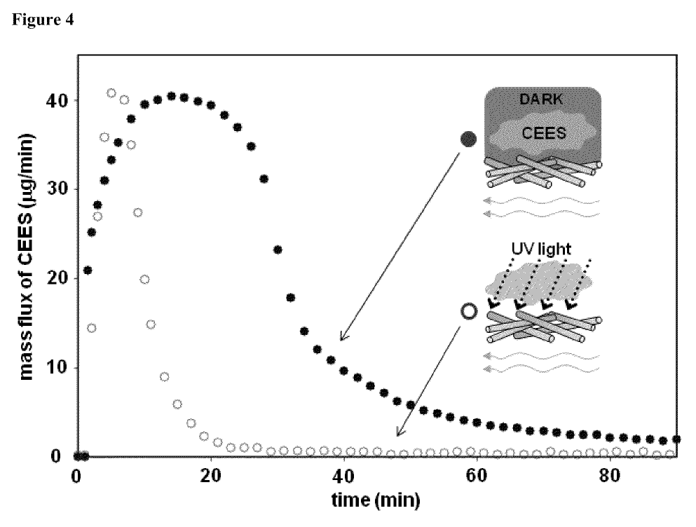

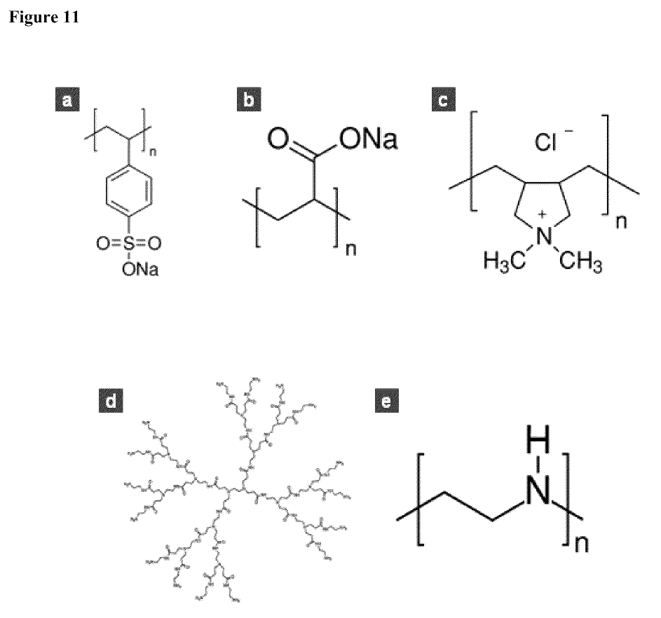

Selecting materials which fit this criterion enabled the creation of asymmetrically functionalized electrospun (ES) membranes using the weak polyelectrolyte systems (LPEI/PAA)ₙ at pH 5 and (PAMAM/PAA)ₙ at pH 4, or the strong polyelectrolyte system (PDAC/PAA)ₙ, as bridging agents (FIG. 11). In the absence of convective driving force (Re_{d} is 0), 50 bilayers of the dendritic PAMAM deposition efficiently bridges the surface pores while penetrating less than 30 μm into the 300 μm thick electrospun membrane. A barrier layer is created near the mat's surface (FIG. 3) reminiscent of asymmetric polymer membranes created by phase inversion. In this case, however, the remaining 90% of the mat contains conformal vac(PDAC/TiO₂) functionality, and is capable of degrading contaminant molecules, with the aid of UV light, during their prolonged residence time in this portion of the membrane. While it appears quite porous, the barrier layer visible in the cross-sectional image is capped with a thin, relatively continuous polymer film (FIG. 1d) covering more than 95% of the surface. Furthermore, since the CEES-barrier properties of the (PAMAM/PAA)₅₀ region are due primarily to solubility effects, the hydrophilic nature of the sublayer and thin-film skin continues to permit water vapor permeation. When compared to ES vac(PDAC/TiO₂) material with no bridged layer, ES vac(PDAC/TiO₂)+(PAMAM/PAA)₅₀ samples demonstrate an increase in photocatalytic capability from 15% to 74%, while maintaining a water vapor flux of 14.3 kg/m²-day (for comparison cotton materials typically allow 12-14 kg/m²-day, while any material demonstrating flux greater than 1 kg/m²-day is categorized as water permeable). This reflects a roughly 0.5% reduction in flux compared to non-bridged ES vac(PDAC/TiO₂). Peak flux of CEES under UV light briefly climbs to similar levels observed in dark tests (FIG. 4) due to some vapor diffusion that occurs rapidly through the remaining pores, but sharply recedes as the detoxifying features of the film activate.

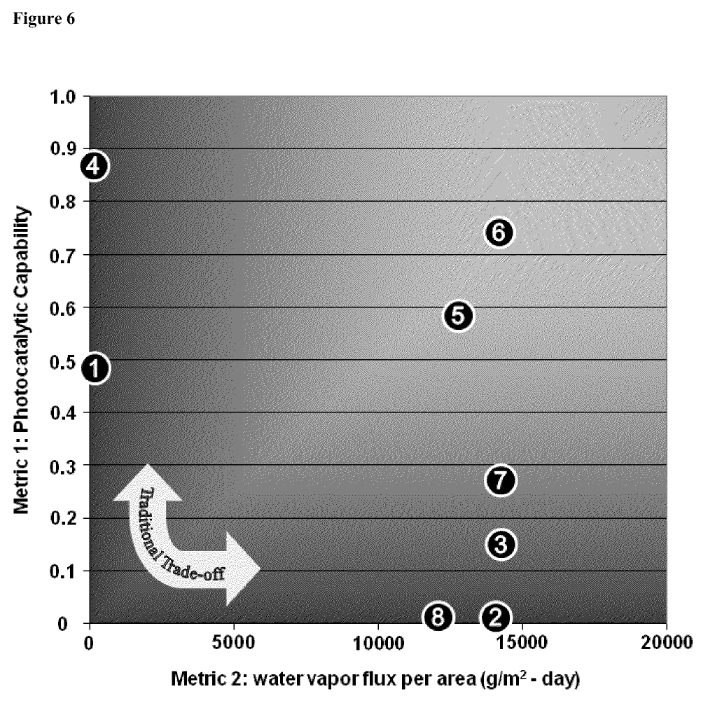

For comparison, measured photocatalytic capabilities as well as water vapor flux rates for ES vac(PDAC/TiO)+(PDAC/SPS)₅₀ and ES vac(PDAC/TiO₂)+(LPEI/PAA)₁₀₀ are tabulated in FIG. 6 Al2O ng with BET surface areas for the two best-performing films. ES vac(PDAC/TiO₂)+(LPEI/PAA)100 demonstrated high water vapor permeability as expected from its low CEES solubility during (LPEI/PAA)ₙ permeability tests. (Note: CEES permeation tests are conducted at ambient humidity, thus solid films that exhibit high water permeability naturally tend to have more moisture present in their matrix. CEES and water mixtures are highly energetically unfavorable, which explains the tendency for high water vapor solubility, thus permeability, and low CEES solubility to go hand in hand.) However, the low molecular weight LPEI (25 k) resulted in a barrier layer with less tendency to bridge the large electrospun pores. Significant amounts of CEES were, therefore, able to pass through via vapor diffusion, avoiding degradation. Higher molecular weight SPS (1 M), in combination with PDAC (150,000), led to a greater degree of pore bridging, as indicated by the membranes' measured surface area decrease from 48.75 to 36.59 m²/g, thus increasing residence time for photocatalytic activity. Similarly, the effects of less hydrophilic SPS in the barrier region and thin-film skin manifest themselves in reduced water vapor flux as compared to samples bridged using the high amine content PAMAM system.

As discussed above, the traditional trade-off between barrier properties and water vapor transport is described graphically in FIG. 6. Materials Al2O ng the axes exhibit either good reactive barrier properties or high water vapor flux, but not both. The ability to control chemical identity, thickness and degree of bridging in the flux-limiting portion of the membrane enables enhancement of the reactive properties while maintaining membrane breathability, producing an engineered textile that exhibits the reactive capability of non-porous barrier materials and water vapor flux similar to highly porous untreated electrospun mats. ES vac(PDAC/TiO₂)+(PAMAM/PAA)₅₀ shows a significant decrease in membrane surface area due to the pore bridging ability of the dendritic PAMAM molecules, as well as high water vapor flux due to their hydrophilic nature.

These results demonstrate a remarkable improvement over current chemical protective measures. Moreover, the applications of the invention are significantly broader in scope. Demonstrated here for high-efficiency reactive gas purification, the self-cleaning functionalities of these membranes can be extended to water purification, by creating and functionalizing filters with reactive capabilities, and to fabric treatment. As a readily scalable platform application, the invention also has potential in the large scale manufacture and treatment of carbon nanotube sheets, as well as the rapidly developing field of biological and tissue engineering by functionalizing high surface area scaffolds with proteins. As the challenges of generating more complex polymer-based membrane systems require engineers to impart new functionalities to materials without sacrificing their mechanical robustness or ease of manufacture, LbL spray-coating of porous nonwovens will provide the versatility to control nanoscale features and functionality on the macroscopic level. Specialized technologies can now be developed in industrially-significant quantities using a rapid, yet inexpensive, scalable approach.

### Fibrous Substrates

In certain embodiments, the fibrous substrates may be woven or non-woven materials. The term “non-woven” refers to a material which is formed by mechanically, thermally, and/or chemically entangling fibers.

In certain embodiments, the fibrous substrates may be non-woven materials formed by electroprocessing. In the present invention, electrospinning is a method for preparing fibrous substrates via electroprocessing (see, for example, U.S. Patent Application Publication No. 2006/0263417, hereby incorporated by reference). The term “electroprocessing” shall be defined broadly to include all methods of electrospinning, electrospraying, electroaerosoling, and electrosputtering of materials, combinations of two or more such methods, and any other method wherein materials are streamed, sprayed, sputtered or dripped across an electric field and toward a target. The electroprocessed material can be electroprocessed from one or more grounded reservoirs in the direction of a charged substrate or from charged reservoirs toward a grounded target. “Electrospinning” means a process in which fibers are formed from a solution or melt by streaming an electrically charged solution or melt through an orifice. “Electroaerosoling” means a process in which droplets are formed from a solution or melt by streaming an electrically charged polymer solution or melt through an orifice. The term electroprocessing is not limited to the specific examples set forth herein, and it includes any means of using an electrical field for depositing a material on a target.

Electrospinning is an attractive process for fabricating fibers due to the simplicity of the process and the ability to generate microscale and nanoscale features with synthetic and natural polymers. Electrospinning uses an electrical charge to form fibers. Electrospinning shares characteristics of both the commercial electrospray technique and the commercial spinning of fibers. The standard setup for electrospinning consists of a spinneret with a metallic needle, a syringe pump, a high-voltage power supply, and a grounded collector. A polymer, sol-gel, composite solution (or melt) is loaded into the syringe and this liquid is driven to the needle tip by a syringe pump, forming a droplet at the tip. When a voltage is applied to the needle, the droplet is first stretched into a structure called the Taylor cone. If the viscosity of the material is sufficiently high, varicose breakup does not occur (if it does, droplets are electrosprayed) and an electrified liquid jet is formed. The jet is then elongated and whipped continuously by electrostatic repulsion until it is deposited on the grounded collector. Whipping due to a bending instability in the electrified jet and concomitant evaporation of solvent (and, in some cases reaction of the materials in the jet with the environment) allow this jet to be stretched to nanometer-scale diameters. The elongation by bending instability results in the fabrication of uniform fibers with nanometer-scale diameters.

A broad range of polymers may be processed by electrospinning, including polyamides, nylons, polyolefins, polyacetals, polylactides, poly(epsilon-caprolactone) (PCL), poly(lactic acid) (PLA), poly(glycolic acid) (PGA), copolymers poly(lactide-co-glycolide) (PLGA), polyacrylonitriles, polyesters, cellulose, cellulose ethers and esters, polyalkylene sulfides, polyarylene oxides, polysulfones, modified polysulfone polymers, polyethylene, polyacrylonitrile, polypropylene, poly(vinylchloride), polymethylmethacrylate, polystyrene, poly(vinylidene fluoride), poly(vinylidene chloride), polyvinyl halides, polyvinyl esters, polyvinyl ethers, polyvinyl alcohols, polyvinyl sulfates, polyvinyl phosphates, polyvinyl amines, polyimides, polyoxidiazoles, polytriazols, polycarbodiimides, polycarbonates, polyarylates, phenol-formaldehyde resins, melamine-formaldehyde resins, formaldehyde-ureas, ethyl-vinyl acetate copolymers, poly(acrylic acid), poly(N-vinylformamide), polyethylene oxide, poly(meth)acrylamide, poly(hydroxyethyl acrylate), hydroxyethylcellulose, methylcellulose, and combinations thereof. Variations of the above materials and other useful polymers include the substitution of groups, such as hydroxyl, halogen, lower alkyl groups, lower alkoxy groups, monocyclic aryl groups, and the like, onto the polymers.

One class of polyamide condensation polymers that can be electroprocessed to form fibrous substrates is nylon materials. The term “nylon” is a generic name for all long chain synthetic polyamides. Typically, nylon nomenclature includes a series of numbers, such as in nylon-6,6 which indicates that the starting materials are a C₆ diamine and a C₆ diacid. Another nylon can be made by the polycondensation of epsilon caprolactam in the presence of a small amount of water. This reaction forms a nylon-6 (made from a cyclic lactam, also known as epsilon-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon-6,6-6,10 material is a nylon manufactured from hexamethylene diamine and a blend of diacids. A nylon 6-6,6-6,10 is a nylon manufactured by copolymerization of epsilon aminocaproic acid, hexamethylene diamine and a blend of a C₆ and a C₁₀ diacid material.

Any solvent can be used that allows delivery of the material or substance to the orifice, tip of a syringe, or other site from which the material will be electroprocessed. The solvent may be used for dissolving or suspending the material or the substance to be electroprocessed. Solvents useful for dissolving or suspending a material or a substance depend on the material or substance. Electrospinning techniques often require more specific solvent conditions. For example, certain monomers can be electrodeposited as a solution or suspension in water, 2,2,2-trifluoroethanol, 1,1,1,3,3,3-hexafluoro-2-propanol (also known as hexafluoroisopropanol or HFIP), isopropanol or other lower order alcohols, especially halogenated alcohols, may be used. Other solvents that may be used or combined with other solvents in electroprocessing natural matrix materials include acetamide, N-methylformamide, N,N-dimethylformamide (DMF), dimethylsulfoxide (DMSO), dimethylacetamide, N-methylpyrrolidone (NMP), acetic acid, trifluoroacetic acid, ethyl acetate, acetonitrile, trifluoroacetic anhydride, 1,1,1-trifluoroacetone, maleic acid, hexafluoroacetone.

Electroprocessing can be used to form fibers, fine fibers, microfibers, nanofibers, fiber webs, fibrous mats, as well as permeable structures, such as membranes, coatings or films. In certain embodiments, the substrates of the invention comprise fibers formed by electroprocessing. Fibers spun electrostatically may have a small diameter. The diameters may be as small as about 0.3 nanometers and are more typically between about 10 nanometers and about 25 microns. In certain embodiments, the fiber diameters are on the order of about 100 nanometers to about 10 microns. In certain embodiments, the fiber diameters are on the order of about 100 nanometers to about 2 microns. Such small diameters provide a high surface-area to mass ratio. Within the present invention, a fiber may be of any length. The term fiber should also be understood to include particles that are drop-shaped, flat, or that otherwise vary from a cylindrical shape.

In certain embodiment, the substrate comprises paper, plastic, steel, or a charged material (e.g., an electret).

In certain embodiments, the substrate is a filter (e.g. an air filter or solid/liquid filter).

In certain embodiments, the substrate is woven material (such as cotton, canvas or nylon).

In certain embodiments, the substrate is dissolvable. In certain embodiments, the substrate is a dissolvable bio-scaffold.

### Layer-By-Layer (LbL) Assembly

The layer-by-layer deposition technique includes the alternating deposition of polyelectrolytes and/or non-charged materials to form at least one bilayer of two different materials.

The term “electrolyte” as used herein means any chemical compound that ionizes when dissolved. The term “polyelectrolyte” or “polyion,” as used herein, refers to a polymer comprising a plurality of charged moieties and which under some set of conditions (e.g., physiological conditions) has a net positive or negative charge. Polycations have a net positive charge, and polyanions have a net negative charge. The net charge of a given polyelectrolyte or polyion may depend on the surrounding chemical conditions, e.g., on the pH and/or salt concentration.

The term “pH” as used herein means a measure of the acidity or alkalinity of a solution, equal to 7, for neutral solutions and increasing to 14 with increasing alkalinity and decreasing to 0 with increasing acidity. The term “pH dependent” as used herein means a weak electrolyte or polyelectrolyte, such as polyacrylic acid, in which the charge density can be adjusted by adjusting the pH. The term “pH independent” as used herein means a strong electrolyte or polyelectrolyte, such as polystyrene sulfonate, in which the ionization is complete or very nearly complete and does not change appreciably with pH.

The term “bilayer” is employed herein in a broad sense and is intended to encompass, a coating structure formed by applying in alternative fashion, and in any order, one layer of a first charged polymeric material and one layer of a non-charged polymeric material or a second charged polymeric material. It should be understood that the layers of the first charged polymeric material and the non-charged polymeric material (or second charged polymeric material) may be partially or completely intertwined with each other in the bilayer.

An exemplary layer-by-layer deposition techniques involves contacting a substrate with a polyelectrolyte, or non-charged material, in a spray or mist form. The process may include the steps of spraying a substrate with a solution of a charged polymeric material; optionally rinsing the substrate by spraying the substrate with a rinsing solution and then optionally drying the substrate; spraying the substrate with a solution of a complementarily charged material, or a non-charged polymeric material which can be non-covalently bond to the charged polymeric material; optionally rinsing the substrate by spraying the substrate with a rinsing solution, thereby forming a bilayer of the charged polymeric material and the non-charged polymeric material. This bilayer formation procedure may be repeated a plurality of times in order to produce a thicker layer-by-layer coating.

The spray coating application may be accomplished via a process selected from the group consisting of an air-assisted atomization and dispensing process, an ultrasonic-assisted atomization and dispensing process, a piezoelectric assisted atomization and dispensing process, an electromechanical jet printing process, a piezo-electric jet printing process, a piezo-electric with hydrostatic pressure jet printing process, and a thermal jet printing process; and a computer system capable of controlling the positioning of the dispensing head of the spraying device on the ophthalmic lens and dispensing the coating liquid. A number of spraying coating processes are described in U.S. Pat. No. 6,811,805 and PCT Publication No. WO/2008/030474, both of which are hereby incorporated by reference in their entirety. By using such spray coating processes, an asymmetrical coating can be applied to a substrate.

In accordance with the present invention, coating solutions can be prepared in a variety of ways. In particular, a coating solution of the present invention can be formed by dissolving a charged polymeric material in water or any other solvent capable of dissolving the materials. When a solvent is used, any solvent that can allow the components within the solution to maintain complementary functionalities for assembly. For example, an alcohol-based solvent can be used. Suitable alcohols include, but are not limited to, isopropyl alcohol, hexanol, ethanol, etc. It should be understood that other solvents commonly used in the art may also be used in the present invention.

Whether dissolved in water or in an organic solvent, the concentration of a material (e.g., a charged polymeric material) in a solution of the present invention can generally vary depending on the particular materials being utilized, the desired coating thickness, and a number of other factors.

A relatively dilute aqueous solution of charged polymeric material may be used. For example, a charged polymeric material concentration can be between about 0.0001% to about 0.25% by weight, between about 0.005% to about 0.10% by weight, or between about 0.01% to about 0.05% by weight.

In general, the charged polymeric solutions mentioned above can be prepared by any method well known in the art for preparing solutions. Once dissolved, the pH of the solution can also be adjusted by adding a basic or acidic material. For example, a suitable amount of 1 N hydrochloric acid (HCl) can be added to adjust the pH to 2.5.

The following are a few of the polymers which may be used in the layer-by-layer depositions of the present invention (wherein n and x are integers):

| Polymer | Polymer | |
|---|---|---|
| Name | Abbreviation | Polymer Structure |
| Mono-sulfonated poly(2,6-dimethyl 1,4- phenylene oxide) | sPPO | 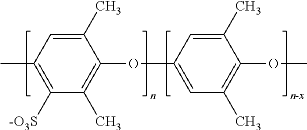 |
| Polyacrylic acid | PAA | 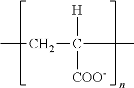 |
| Polyacrylamide | PAAm | 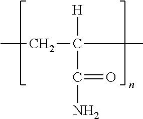 |
| Poly(allylamine hydrochloride) | PAH | 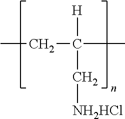 |
| Polymethacrylic acid | PMA | 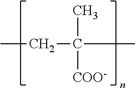 |
| Polystyrene sulfonate | SPS | 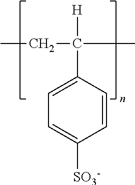 |
| poly(amidoamine) (note: G4 as used herein, but drawn as G1 for clarity) | PAMAM | 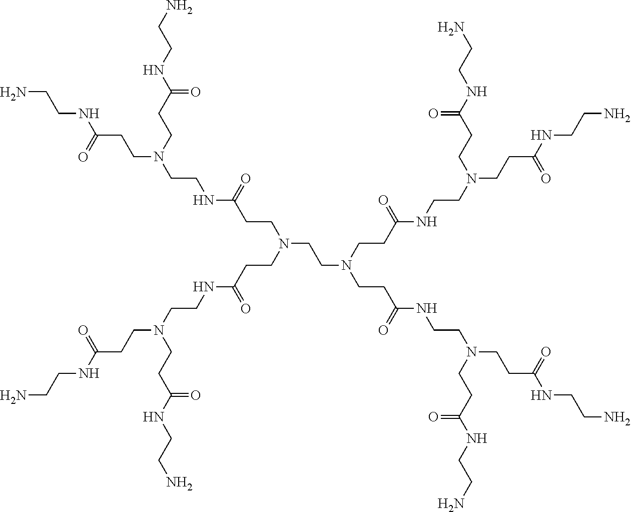 |
| poly(4-vinylpyridine) | P4VP | 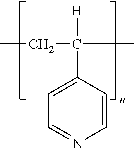 |
| Polydiallyldimethyl- ammonium chloride | PDAC | 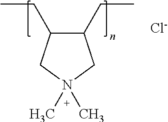 |
| Linear Poly(ethyleneimine) | LPEI | 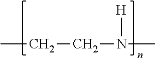 |
| Poly(ethyleneoxide) | PEO | 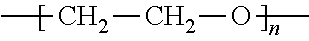 |
| Poly(2-acrylamido-2- methyl-1-propane sulfonic acid) | PAMPS | 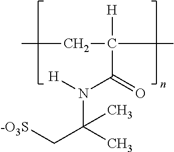 |
| Poly(vinylpyrrolidone) | PVP | 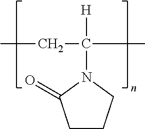 |
| Poly(vinylalcohol) | PVA | 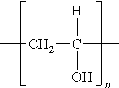 |
| Poly(ethylene glycol) | PEG | 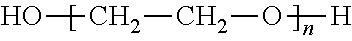 |
| Poly(aniline) | PANI | 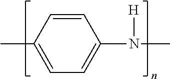 |
| Poly(styrene sulfonic acid-maleic acid) | PSSM3:1 | 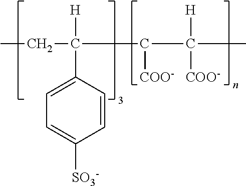 |
| Poly(acryl-co- acrylamide acid) | PAA-co-AAm | 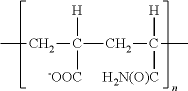 |
| Poly(dimethylamine- co-epichlorohydrin) | PDME | 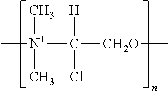 |

The foregoing list is intended to be exemplary and is not exhaustive. A person skilled in the art, given the disclosure and teachings herein, would be able to select a number of other useful charged polymeric materials, such as, for example, sulfonated polyanions of polysulfones or polyetherketones.

In certain embodiments, metal oxide nanoparticles may be used in the assembly layer-by-layer films. The term “metal” is also used herein to include metalloids belonging to groups 13-15 of the Periodic table. (For purposes of this invention, the chemical elements are identified in accordance with the Periodic Table of the Elements, CAS version, Handbook of Chemistry and Physics, 67th Ed., 1986-87, inside cover.) In other words, the metal in the metal oxide nanoparticles of the present invention may be Li, Na, K, Mg, Ca, Sr, Ba, Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, B, Al, Ga, In, Tl, Si, Ge, Sn, Pb, As, Sb, Bi or a lanthanide such as Ce. Examples of metal oxides include TiO₂, Ta₂O₅, Nb₂O₅, ZrO₂, Y₂O₃, Al₂O₃, and SiO₂. The metal oxide may also be a mixed oxide containing two, three, four or five different metals.

The term “nanoparticle” refers to particles which have an average diameter of between about 1 and about 500 nanometers. In certain embodiments, a nanoparticle may have an average diameter of between about 1 and about 100 nanometers.

### EXEMPLIFICATION

The invention now being generally described, it will be more readily understood by reference to the following, which is included merely for purposes of illustration of certain aspects and embodiments of the present invention, and is not intended to limit the invention.

### Electrospun Materials Synthesis

Nonwoven meshes of nylon fibers were made by electrospinning a solution of 10% nylon-6,6 (45,000 M_{w}) (Scientific Polymer Products) in hexafluoroisopropanol (Aldrich) at 0.1 mL/min with a needle-to-collector distance of 31 cm and a source voltage of 26.8 kV for 40 minutes using a parallel plate electrospinning apparatus. Mats were soaked in 0.02 M aqueous solution of PAH (56,000 M_{w} (Aldrich) for 30 minutes prior to LbL treatment.

### LbL Film Assembly

LPEI (25,000 M_{w}) (Polysciences), PAA (15,000 M_{w}, 35% aqueous solution) (Aldrich), PAMAM (G4, 22% solution in methanol) (Dendritech), SPS (1,000,000 M_{w} (Aldrich) and PDAC (150,000 M_{w}, 20% aqueous solution) (Aldrich) were used as received and prepared as 0.02 M solutions, based on the repeat unit molecular weight, in Milli-Q water. A colloidal solution of TiO₂ nanoparticles was synthesized (as described in Krogman, K. C., Zacharia, N. S., Grillo, D. M., & Hammond, P. T., Photocatalytic layer-by-layer coatings for degradation of acutely toxic agents. Chem Mater 20 (5), 1924-1930 (2008)) and diluted to a concentration of 1.65 mg/mL.

Conformal (TiO₂/PDAC)ₙ coatings were then deposited using a vacuum assisted Spray-LbL technique. See PCT Publication No. WO/2008/030474, which is hereby incorporated by reference in its entirety. Four inch diameter circles of electrospun Nylon were cut and mounted on coarse mesh stainless steel wire cloth (9×9 mesh) which had been previously fixed in the mouth of a large funnel. The other end of the funnel was connected via rubber tubing to an adjustable-flow single stage vacuum generator operating on compressed air, which was adjusted prior to operation to set the flow rate of air through the electrospun mat during spray deposition. The flow rate, and hence Re number, were determined using a high sensitivity anemometer. During operation the mat was held in place on the wire mesh only by vacuum. Atomized sprays of solutions were formed using modified air-brushes assembled into an automated system, and driven by compressed ultra-pure argon regulated to 20 psi. Cationic PDAC (150,000 M_{w}, 20% aqueous solution) (Aldrich) solution was first sprayed for 3 seconds at a rate of 0.2 mL/s at a sufficient distance and cone angle to reach the entire cross section of the mounted mat simultaneously. Two seconds later pH 10 rinse water was sprayed from a similar distance for 10 seconds, and allowed 2 seconds for the bulk to be removed by vacuum. This half cycle was repeated for the anionic TiO₂, and the total cycle (34 seconds) was repeated 25 times to develop the conformal coating.

Vacuum was removed and the mat flipped and remounted. No further drying time was necessary, and the still-damp mat was easily mounted on the same stainless steel screen. Bridged coatings were formed using LPEI (25,000 M_{w}) (Polysciences), PAA (15,000 M_{w}, 35% aqueous solution) (Aldrich), PAMAM (G4, 22% solution in methanol) (Dendritech), SPS (1,000,000 M_{w}) (Aldrich) and PDAC prepared as 0.02 M solutions, based on the repeat unit molecular weight, in Milli-Q water. While the same spray geometry was used, the time between sprays was increased from 2 seconds to 6 seconds. In the absence of vacuum solutions were observed to cascade down the mat surface, and therefore were allowed greater rest time (50 second cycle).

### Characterization

Mats were coated with a 10 nm layer of Au/Pd and imaged using a JEOL JSM-6060 Scanning Electron Microscope. Average fiber diameter was determined by measuring 40 to 60 individual fibers on both sides of the electrospun mat. Surface area measurements were performed by BET (Micromeritics, ASAP 2020), and verified using both nitrogen and krypton as the adsorbent gas.

### Permeation Testing

Treated mats were mounted in a stainless steel permeation cell and subjected to a saturated vapor of CEES (Aldrich) evolving from a 3 μL, drop. Meanwhile a stream of ultrapure compressed air (AirGas) was passed at 50 SCCM beneath the sample and analyzed using a Total Hydrocarbon Analyzer (Gow-MAC Instruments, Series 23-550) equipped with a flame ionization detector. During UV testing the photocatalytic side of the material was also exposed to a UV spot source (Dymax, Blue Wave 200) filtered to 50 mW/cm² intensity. Note, although CEES is a less toxic simulant for HD mustard gas extreme caution should still be exercised when working with it. Water vapor permeation tests were conducted using a Dynamic Moisture Permeation Cell by passing air at two different relative humidities over opposite sides of the treated mat, and measuring the change in water vapor in each stream.

### INCORPORATION BY REFERENCE

All U.S. patents and U.S. published patent applications cited herein are hereby incorporated by reference in their entireties.

### EQUIVALENTS

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

We claim:

1. A multi-functional material, comprising a porous, fibrous substrate, wherein substantially all of the fibers of the substrate are conformally coated with a first layer-by-layer film, and substantially all of the pores in the substrate are at least partially filed with a second layer-by-layer film.

2. The material of claim 1, wherein the substrate comprises electrospun fibers.

3. The material of claim 1, wherein the first layer-by-layer film comprises a cationic polyelectrolyte.

4. The material of claim 3, wherein the cationic polyelectrolyte is PDAC.

5. The material of claim 1, wherein the first layer-by-layer film comprises an anionic metal oxide nanoparticle.

6. The material of claim 5, wherein the anionic metal oxide nanoparticle is TiO₂.

7. The material of claim 1, wherein the first layer-by-layer film comprises between 1 and about 200 bilayers.

8. The material of claim 1, wherein the first layer-by-layer film is (PDAC/TiO₂)₂₅.

9. The material of claim 1, wherein the second layer-by-layer film comprises a cationic polyelectrolyte.

10. The material of claim 9, wherein the cationic polyelectrolyte is PDAC, PAMAM (G4), PAH or LPEI.

11. The material of claim 1, wherein the second layer-by-layer film comprises an anionic polyelectrolyte.

12. The material of claim 11, wherein the anionic polyelectrolyte is SPS or PAA.

13. The material of claim 1, wherein the second layer-by-layer film comprises between 1 and about 200 bilayers.

14. The material of claim 1, wherein the second layer-by-layer film is (PDAC/SPS)₅₀, (PAMAM/PAA)₅₀, (PAH/PAA)₁₀₀ or (LPEI/PAA)₁₀₀.

15. The material of claim 1, wherein said material is a selectively-reactive gas purification membrane, a self-cleaning fabric, a material used for water purification, or a protein functionalization scaffold used for tissue engineering.

16. A method of fabricating a multi-functional material from a porous, fibrous substrate comprising the steps of:
alternatingly depositing a first material and a second material on a porous, fibrous substrate, thereby conformally coating the fibers of the substrate with a first layer-by-layer film; and
alternatingly depositing a third material and a fourth material on the conformally coated substrate, thereby at least partially filling the pores in the substrate with a second layer-by-layer film.

17. The method of claim 16, wherein the substrate comprises electrospun fibers.

18. The method of claim 16, wherein the first layer-by-layer film is deposited by a spray assisted layer-by-layer process.

19. The method of claim 18, wherein the spray assisted layer-by-layer process comprises the steps of spraying a first material from a first distance, at a first rate, for a first time, onto the substrate; and spraying a second material from a second distance, at a second rate, for a second time, onto the substrate.

20. The method of claim 19, wherein the spray assisted layer-by-layer process further comprises the step of imposing a pressure gradient across the substrate while the fibers in the substrate are conformally coated with the first layer-by-layer film.

21. The method of claim 16, wherein the second layer-by-layer film is deposited by a spray assisted layer-by-layer process.

22. The method of claim 21, wherein the spray assisted layer-by-layer process comprises the steps of spraying a third material from a third distance, at a third rate, for a third time, onto the conformally coated substrate; and spraying a fourth material from a fourth distance, at a fourth rate, for a fourth time, onto the conformally coated substrate.

23. The method of claim 16 wherein the substrate has a first side and a second side; the first layer-by-layer film is deposited by a spray assisted layer-by-layer process applied to the first side of the substrate; and the second layer-by-layer film is deposited by a spray assembly layer-by-layer process applied to the second side of the substrate.

24. The method of claim 16, wherein said material is a selectively-reactive gas purification membrane, a self-cleaning fabric, a material used for water purification, or a protein functionalization scaffold used for tissue engineering.
